(19) United States
(12) Patent Application Publication
(10) Pub. No.: US 2015/0027906 A1
(43) Pub. Date: Jan. 29, 2015

(54) SOLID POLYMER ELECTROLYTE AMMONIA SENSOR

(71) Applicant: Hamilton Sundstrand Corporation, Charlotte, NC (US)

(72) Inventors: Lei Chen, South Windsor, CT (US); Hsien-chi W. Niu, Rowland Heights, CA (US); Joseph V. Mantese, Ellington, CT (US)

(73) Assignee: Hamilton Sundstrand Corporation, Charlotte, NC (US)

(21) Appl. No.: 13/949,460

(22) Filed: Jul. 24, 2013

(51) Int. Cl. G01N 27/407

(52) U.S. Cl. CPC G01N 27/4074
USPC 205/780.5; 204/415

(57) ABSTRACT

An ammonia sensor that includes an ionic liquid impregnated sensing electrode (anode) and a cathode separated by a membrane. During operation, in the presence of ammonia, the anode and cathode generate current manifesting the electrochemical reaction of ammonia in the sensing electrode. Ionic liquids distributed in the ionomer film in the gas diffusion electrodes ensure the reactivity under wide range of environment conditions while maintaining the ability of the device to quantify ammonia concentration in the environment. The sensor can therefore sustain long time operation without internal humidification due to the non-volatility of the ionic liquids.

### TECHNICAL FIELD

The present teachings relate to the field of chemical sensors and, more particularly, to an electro-chemical sensor for detecting ammonia.

### BACKGROUND

Ammonia (NH₃) is commonly used in many industries, including petrochemical refining, pulp and paper manufacture, fertilizer formulations, oil industry and refrigeration. Particularly, anhydrous ammonia is widely used as a coolant in large industrial refrigeration systems. The use of ammonia as a refrigerant (R717) has increased substantially over the past several years as a replacement for environmentally unfriendly chlorofluorocarbon refrigerants. However, ammonia is a highly toxic gas having an eight-hour time weighted average (TWA) of 25 parts per million (ppm). Further, ammonia is an explosively flammable gas with a lower explosive limit (LEL) of approximately 15% by volume. Ammonia that is mixed or contaminated with lubricating oil, however, may catch fire or explode at concentrations as low as 8%. Additionally, the US Environmental Protection Agency (EPA) is enforcing more stringent emissions standards on the automobile industry and the power industry. In particular, NOₓ and ammonia are two pollutants that the EPA is mandating automobile manufacturers and power plants to monitor.

Because of these hazards, the detection of NH₃ gas is a concern and has been performed using a number of different techniques, for example using nondispersive infrared (NDIR) sensors, chemisorption metal oxide semiconductor (MOS) sensors, charge carrier injection (CI) sensors, and traditional electrochemical (EC) sensors. NDIR sensors are chemically stable and detect NH₃ with good specificity to NH₃ and a low occurrence of false positives, but they are relatively expensive to manufacture and are susceptible to interference from high temperature and humidity. Chemisorption MOS sensors have a relatively low cost, can detect NH₃ at low ppm, and have a long life, but have a cross sensitivity, for example, to fluorocarbons, carbon monoxide, hydrogen, and alcohols, and thus have relatively high occurrences of false positives. Further, chemisorption MOS sensors exhibit non-linear responses and are humidity dependent. CI sensors function sufficiently over a wide range of NH₃ concentrations and temperatures and have a relatively long life, but have a cross sensitivity to other gasses and are less sensitive to lower atmospheric NH₃ concentrations, for example at concentrations of less than about 20 ppm.

Electrochemical gas sensors are widely used for sensing a variety of gases. Although the specific design features of these sensors can vary widely based on the electrochemical reactions of the gas species being sensed, the environments in which the sensors are used, and other factors, the sensors generally share common features, such as having two electrodes (an anode and a cathode) separated by an electrolyte. EC sensors may include the use of an electrolyte, including solid oxide electrolytes demanding high temperature operation and fabrication processes, in the detection of NH₃. See, for example, the following U.S. Pat. Nos. 7,828,955; 8,257,576; 6,676,817; each of which is incorporated herein by reference in its entirety. Solid oxide (ceramic) electrolyte based ammonia sensors rely on the potential difference between a sensing electrode and a reference electrode to quantify the ammonia concentration as prescribed by the Nernst equation, E=E⁰+(RT/zF)ln(Pₛ/Pᵣ), i.e. Nernstian electrochemical principles. Though ceramic electrochemical sensors are suitable for engine exhaust gas analysis, their high temperature operation can limit the applications requiring low power or wireless operation. The Nernstian relationship also entails a non-linear correlation of sensor output with ammonia concentration. Compared with the aforementioned detection technologies, EC detection of NH₃ in aqueous and polymer electrolytes has been attractive due to the relatively compact size, low cost, low power consumption, linearity, and adjustable sensitivity. Ammonia is a weak base; therefore, basic electrolyte is more appropriate for constructing an aqueous ammonia EC sensor. These EC sensors can be made to operate in the diffusion limited regimes, hence allowing amperometric determination of ammonia concentrations where the sensor output current is proportional to the ammonia concentrations. The sensing electrode reaction is given as 2NH₃-6e⁻→N₂+6H⁺, which is balanced by a reaction at the counter electrode related to oxygen reduction, O₂+4e⁻+H⁺→2H₂O. However, traditional room-temperature EC sensors using liquid aqueous electrolytes may be prone to electrolyte loss arising from neutralization by the carbonate acid produced by atmospheric carbon dioxide. Additionally, dry-out due to water evaporation also greatly limits the lifetime of aqueous electrolyte ammonia sensors.

In other designs of EC ammonia sensors where organic gel electrolytes are used, consumption or even depletion of the electrolytes resulting from oxidation of NH₃ during detection are also known to limit the lifetime of the sensors. As such, extended exposure to low levels of NH₃ or shorter exposure to high levels of NH₃ is generally not recommended for these types of ammonia sensors.

To address the issues associated with aqueous ammonia EC sensors, organic solvents such as propylene carbonate and non-volatile ionic conductors such as ionic liquids have been explored for ammonia detection. See, for example, B. A. L'opez de Mishima, H. T. Mishima, “Ammonia Sensor Based on Propylene Carbonate,” Sensors and Actuators. B 131 (2008): 236-240; and Xiaobo Ji, et al., “Electrochemical Ammonia Gas Sensing in Nonaqueous Systems: A Comparison of Propylene Carbonate with Room Temperature Ionic Liquids,” Electroanalysis. 19, 2007, No. 21, 2194-2201, each of which is incorporated herein by reference in its entirety. In these reported efforts, either bulk platinum electrodes or pure platinum black mixed with polytetrafluoroethylene (e.g., Teflon®) is used as the sensing electrodes. Liquid electrolytes, propylene carbonate, or ionic liquids used in the experiments must be disposed in a gas diffusion electrode in a delicate way to achieve optimal detection performance. In some cases, bulk ionic liquids can substantially reduce the sensitivity of the sensor due to the transport limitation of ammonia in the bulk ionic liquids. In addition, un-supported electrolytes are not amenable to mass production (see, for example, L'opez and Ji, supra).

A compact, low cost, low power, and highly sensitive NH₃ sensor that has low or no consumption of electrolyte and therefore lasts longer than some aqueous electrolyte EC NH₃ sensors, and an NH₃ sensor operational in a wide range of temperatures is also a requirement for some applications where sub-freezing temperatures are common, would be desirable.

### SUMMARY

The following presents a simplified summary in order to provide a basic understanding of some aspects of one or more embodiments of the present teachings. This summary is not an extensive overview, nor is it intended to identify key or critical elements of the present teachings nor to delineate the scope of the disclosure. Rather, its primary purpose is merely to present one or more concepts in simplified form as a prelude to the detailed description presented later.

In an embodiment, an ammonia sensor may include a gas diffusion sensing electrode comprising a first catalyst support, a first nanocatalyst, and a first ion-conducting ionomer film with porosity ranging from 20% to 80%, wherein the first nanocatalyst and the first ion-conducting ionomer film are supported by the first catalyst support and the ionomer is impregnated with ionic liquids. The ammonia sensor may further include a membrane comprising an ion conducting polymer, a gas diffusion counter electrode comprising a second catalyst support, a second nanocatalyst, and a second ion-conducting ionomer film, wherein the second nanocatalyst and the second ion-conducting ionomer film are supported by the second catalyst support, wherein the membrane is directly interposed between the sensing electrode and the counter electrode, a first housing portion electrically coupled to the sensing electrode, wherein the first housing portion comprises an opening therein that exposes the sensing electrode to an environment, and a second housing portion electrically coupled to the counter electrode, wherein the ammonia sensor is configured such that the sensing electrode is electrically coupled to the counter electrode via at least one of a potentiostatic and a galvanostatic circuitry for determining the presence and quantity of ammonia in the environment.

In another embodiment, a method for detecting the presence of environmental ammonia may include providing a membrane comprising a polymer matrix, interstitial spaces within the polymer matrix, and an ionic liquid within the interstitial spaces, providing a gas diffusion sensing electrode comprising a first catalyst support, a first nanocatalyst, and a first ion-conducting ionomer film, wherein the first nanocatalyst and the first ion-conducting ionomer film are supported by the first catalyst support, providing a gas diffusion counter electrode comprising a second catalyst support, a second nanocatalyst, and a second ion-conducting ionomer film, wherein the second nanocatalyst and the second ion-conducting ionomer film are supported by the second catalyst support, wherein the membrane is directly interposed between the sensing electrode and the counter electrode, and providing a first housing portion electrically coupled to the sensing electrode, wherein the first housing portion comprises an opening therein that exposes the sensing electrode to an environment. The method may further include providing a second housing portion electrically coupled to the counter electrode, and detecting the presence or absence of ionic conduction via the membrane between the first housing portion and the second housing portion, wherein charge transfer between the first housing portion and the second housing portion indicates the presence of environmental ammonia and the absence of ionic current between the first housing portion and the second housing portion indicates the absence of environmental ammonia.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 is a cross section schematic of a hybrid solid phase extraction (SPE) electrochemical ammonia sensor;

FIG. 2 is a perspective depiction of some of the FIG. 1 device elements;

FIG. 3 is a perspective depiction of a method for forming a membrane electrode assembly (i.e., MEA) of an SPE electrochemical ammonia sensor in accordance with an embodiment of the present teachings;

FIG. 4 is a perspective depiction of another method for forming a MEA in accordance with another embodiment of the present teachings;

FIG. 5 is cross section schematic depiction of a supported nanocatalyst/ionomer agglomerate in an electrode of one embodiment of the present teachings; and

FIG. 6 is a schematic depiction of a hybrid electrolyte impregnated catalyst used to form an electrode in accordance with another embodiment of the present teachings.

It should be noted that some details of the FIGS. have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same or like parts.

The present teachings relate to an ammonia sensor for detecting and further quantifying ammonia gas in a gas stream or atmosphere. Although the sensor is described in relation to a laminated membrane electrode assembly (i.e., MEA) where an ion-conducting membrane is sandwiched between two electrodes, other sensor designs can also be used, such as planar design and the like. An embodiment of the present teachings may include an electrochemical (EC) ammonia sensor that uses a hybrid electrolyte supported in a solid polymer electrolyte. The sensor may detect levels of ammonia over an extended period of time without depleting the chemical reactants within the sensor, and thus has a long lifetime. An embodiment of the present teachings may include an EC ammonia sensor that uses functionalized gas diffusion electrodes to detect the presence of gaseous ammonia. Contact between reactant chemicals in the sensor and gaseous ammonia generates an ion pump or proton pump which, in turn, generates a current output that significantly exceeds the background signal of the device and can be detected or measured using a circuit that may include at least one of a potentiostatic and a galvanostatic circuitry, and signal processing electronics.

An embodiment of the present teachings may provide an ammonia sensor with an electrochemical cell using ion-conducting polymer electrolyte impregnated with ionic liquids and/or organic solvents to perform stably over an extended lifetime with a chemical selectivity over a wide range of environment conditions. Further, an embodiment of the present teachings may include the use of impregnated cation exchange ion-conducting polymer (ionomer) as a hybrid electrolyte to mitigate the limitations revealed in the prior art. Chemicals to be immobilized in the polymer electrolyte include either ionic liquids or organic solvents or the combination of these two types of chemicals. In addition to an extended lifetime, a hybrid electrolyte design, particularly in the gas diffusion electrodes for gas sensing, may lead to a range of selectivity against other gases that can interfere with the detection of ammonia.

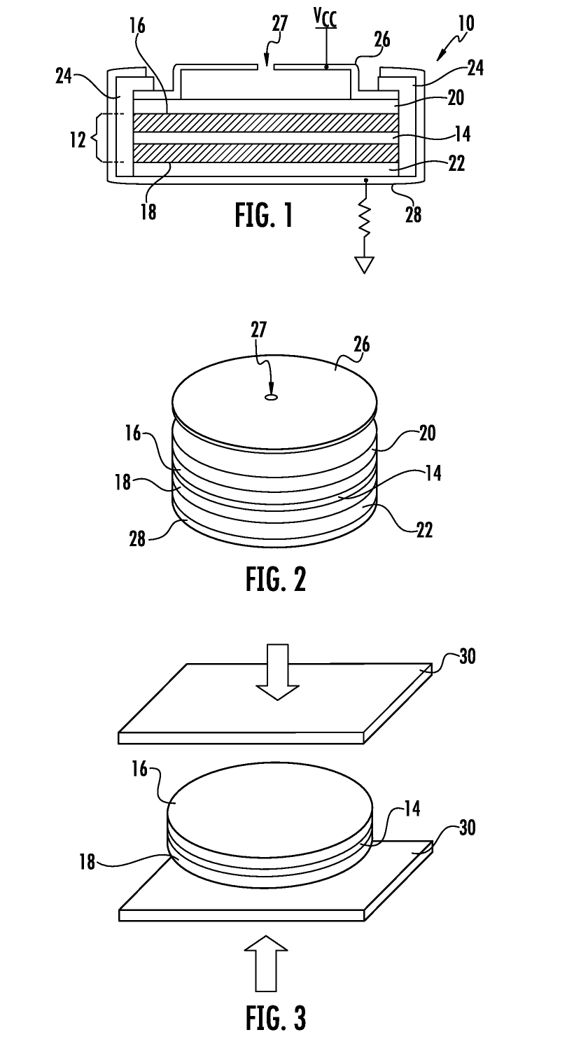

An ammonia sensor 10 in accordance with an embodiment of the present teachings is depicted in the cross section of FIG. 1 and the partial perspective depiction of FIG. 2. It will be understood that the embodiments depicted in the FIGS. are generalized schematic illustrations and that other components may added or existing components may be removed or modified.

An ammonia sensor 10 may include a membrane electrode assembly (MEA) 12 including an ion-exchange (ion-conducting) membrane 14 interposed directly between, and in physical contact with, a pair of electrodes. The electrode pair may include a gas diffusion anode 16 having a porosity varying from 20% to 80% and a gas diffusion cathode 18 having a similar porosity as the anode, wherein the electrode pair forms part of an electrical circuit. The membrane is fabricated from a material that includes an ionic liquid retained therein. A first current collector/gas diffusion layer 20 may physically contact the anode 16, and a second current collector/gas diffusion layer 22 may physically contact the cathode 18. The ammonia sensor 10 may further include a dielectric (electrically insulative) seal 24 that seals an edge of the MEA to prevent gas from bypassing the ion-conducting membrane 14. The internal structures may be sealed within a housing comprising an upper housing portion 26 electrically isolated from a lower housing portion 28. The upper housing portion 26 is electrically coupled to the anode 16 through physical contact with the electrically conductive first current collector/gas diffusion layer 20. The lower housing portion 28 is electrically coupled to the cathode 18 through physical contact with the electrically conductive second current collector/gas diffusion layer 22. The upper housing portion 26 include one or more holes, voids, or openings therein 27 for the entry of gas (ammonia) from the atmosphere or environment into the sensor 10. The hole 27 may be sized to permit entry of a desired amount of gas into the sensor depending, for example, on anticipated gas concentrations.

The ion-exchange membrane 14 may be manufactured from various materials. In an embodiment, the ion-exchange membrane 14 may be manufactured from a sulfonated tetrafluoroethylene based fluoropolymer-copolymer, such as Nafion®, in its proton (H+) form (available from DuPont of Wilmington, Del.), NH₄⁺, Li⁺, Na⁺, K⁺, Ag⁺, or the like, or can be ion-exchanged to have various cations, or another ion-conducting polymeric material. Exemplary polymers to provide a polymer membrane may include any polymer capable of forming a matrix structure that is able to retain the ionic liquid. For larger matrix structures like mesoporous or microcellular structures, the polymer membrane should form a structure having surface characteristics as well as porosity or cellular characteristics that allow the structure to retain the ionic liquid, and virtually any polymer capable of forming such structures may be used, including but not limited to polyesters (including polyoxyalkylene esters), polyolefins, polyurethanes, acrylic polymers, polyimide, polysulfone, polyarylsulfone, polybenzimidazole (i.e., “PBI”), co-polymers (e.g., poly-arylene-ether-sulfone co-polymers or block-copolymers), polyetherimide-siloxane copolymers, perfluorinated polymers (e.g., polytetrafluoroethylene, i.e., “PTFE”, and perfluoroalkoxy copolymer, i.e., “PFA”), and partially fluorinated polymers (e.g., polyvinylidene fluoride, i.e., “PVDF”). The type of polymer molecular structure can be important in selection of a polymer to retain an ionic liquid in a nano-scale polymer matrix. The polymer may be non-ionic or it may be ionic (e.g., DuPont Nafion® ionomer). Useful non-ionic polymers for retaining the ionic liquid on such a scale include but are not limited to polyoxyalkylene (i.e. polyoxyethylene), per- or partially fluorinated polymers (i.e., PFA, PTFE, PVDF), polystyrene, heteroaromatic polymers (such as polyaniline, polypyrrole, PBI). Useful ionic polymers may include ionic groups attached to a polymer so that the polymer has the ionic-exchange ability, such groups including but not limited to sulfonic acid, phosphonic acid, and sulfonimide acid. Exemplary ionomers include per-fluorinated sulfonic acid (“PFSA”), such as Nafion® ionomer and Solvey Solexis Auqivion™ ionomer, sulfonated polystyrene, sulfonated polysulfon, disulfonated poly(arylene ether sulfone) block-copolymers (“BPSH”). Conventional additives, e.g., surfactants, solvents (e.g., polyethylene glycol), and fine particles (such as functionalized of non-functionalized silica, carbon-based powders, metal-oxides particles) may also be added to the polymer matrix. The membrane 14 is an electrical insulator but permits the passage of ions so that an electrical potential can be generated between the anode 16 and cathode 18 as described below.

In an embodiment, the ion-exchange membrane 14 may have a thickness of between about 1 micrometer (μm) and about 200 μm, more specifically from about 5 μm to about 100 μm.

In an embodiment, the anode 16 and cathode 18 may also be manufactured from, for example, Nafion in combination with the other materials described below, which differentiates a Nafion membrane 14 (for example, a pure Nafion or pure polymer membrane 14 impregnated with an ionic liquid in interstitial spaces) from the partially Nafion impregnated anode 16 and cathode 18. The electrodes 16, 18 may also be formed from any of the ionomers stated supra, and may each have a thickness raging from about 1 μm to about 100 μm. The electrodes 16, 18, may be impregnated with an ion or proton source such as ionic liquids and/or organic solvents, or cation exchange ion-conducting polymer (ionomer) as described below.

Each gas diffusion layer 20, 22 of FIGS. 1 and 2 may be manufactured from an inert, porous, electrically conductive material such as carbon paper or an electrically conductive fibrous medium such as metal felt. The gas diffusion layers 20, 22 function as a gas diffusion medium and current collector. The seal 24 may be manufactured from any inert, electrically insulative material such as polymer, rubber, etc.

Various methods for forming the membrane electrode assembly 12 are contemplated. In FIG. 3, anode material 16 and cathode material 18 were printed onto a pre-formed membrane material 14 and placed into a press 30. During a hot pressing process, for example at a temperature of between about 90° C. and about 130° C., an opposing pressure is applied between the anode 16 and the cathode 18, for example in the range of about 50 psi to about 200 psi, to bond the anode 16 to the membrane 14, and the membrane 14 to the cathode 18.

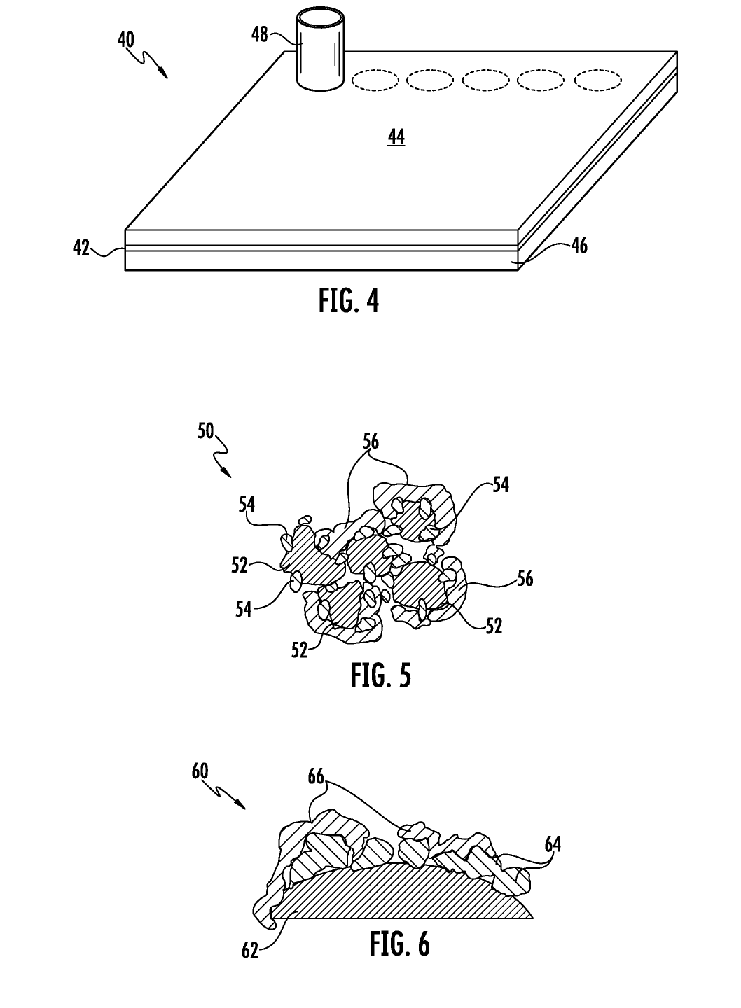

In another process depicted in FIG. 4, the MEA 12 of FIG. 1 may be cut from a larger piece of a pre-fabricated MEA 40, for example including a membrane layer 42 interposed between a first electrode layer 44 and a second electrode layer 46. In an embodiment, a die 48 may be used to cut and form the MEA 12 from the membrane layer 42 and the electrode layers 44, 46. The mat 40 may be formed using a casting process or a hot pressing process.

In an exemplary embodiment of an ammonia sensor 10, the electrodes 16, 18 may include a supported nanocatalyst/ionomer agglomerate 50 as depicted in FIG. 5. The agglomerate 50 can include a catalyst support 52, for example an electrically conductive support or oxide semiconductor. The catalyst support 52 is used to support a nanocatalyst 54, for example a precious metal catalyst, and a solid ionomer film 56. The agglomerate 50 may be prepared, for example, by supporting the nanocatalyst 54 with the catalyst support 50. Subsequently, the supported nanocatalyst 54 is impregnated with a proton-conducting ionomer 56 by mixing the catalyst with the isomer dispersant followed by a casting and drying process to form the agglomerate 50. In an embodiment, the support 52 can include a plurality of carbon particles 52 with a nominal diameter of, for example, about 40 nm. The nanocatalyst 54 may include a plurality of precious metal particles, for example one or more of platinum, gold, silver, or palladium particles having a nominal diameter of, for example, about 4 nm. The ion-conducting ionomer 56 may be a thin layer of material such as Nafion®.

In an exemplary embodiment, each electrode 14, 16 may also contain an ionic liquid retained in the ionomer 56 or in the otherwise vacant pores of the nanocatalyst 52. Each gas diffusion electrode prepared as described herein essentially includes a hybrid electrolyte with cations in the solid polymer electrolyte (i.e., material 56) being at least partially exchanged by the ions in the ionic liquids retained in the material of the MEA membrane 14, for example within a Nafion membrane 14. The material 50 of FIG. 5 may be used to form electrodes 16, 18, for example, by depositing material 50 using screen printing, inkjet printing, metal vapor deposition, casting, or other deposition techniques depending on the composition and characteristics of the electrode. Agglomeration 50 may thus be deposited onto either side of a pre-formed electrolyte membrane to form a membrane 14 sandwiched between two electrodes as depicted in FIG. 1. In another embodiment, a first electrode or electrode layer (for example, layer 18) may be formed from agglomeration 50, followed by deposition of the electrolyte membrane layer (for example, layer 14) onto the first electrode or electrode layer, followed by deposition of a second electrode or electrode layer (for example, layer 16) onto the membrane layer.

FIG. 6 depicts a hybrid electrolyte impregnated catalyst. The agglomeration 60 of FIG. 6 includes a catalyst support particle 62, a nanocatalyst 64, and an ionomer film 66 which fills voids between the nanocatalyst 64. The ionomer film may be impregnated with at least one of an ionic liquid and/or an organic solvent. The FIG. 6 structure includes triple phase boundaries where gas/hybrid ionomer electrolyte catalyst are all present.

In exemplary embodiments as described herein, the electrolyte for an MEA for a gas sensor is provided by the membrane. The membrane resides between the sensing electrode (e.g., the anode 16) and the reference electrode (e.g., the cathode 18). This membrane 14 includes an ionic liquid retained therein. Ionic liquids are generally recognized in the scientific literature as being salts having a melting point below 100° C.; however, the melting point for ionic liquids useful in the exemplary embodiments described herein can vary depending on the anticipated operating temperatures of the gas sensor, and could even be higher than 100° C. for high-temperature applications. In exemplary embodiments for sensors to be used in normal ambient conditions, ionic liquids used within the membrane 14 having a melting point below 0° C. will provide performance at temperatures at least as low as the freezing point of water. Many ionic liquids offer high electrochemical stability (e.g., up to roughly 6 V vs. Standard Hydrogen Electrode, SHE, compared to 1.23V vs. SHE for water) and/or high conductivity (>1 mS/cm, and up to 100 mS/cm under ambient temperature). The electrochemical stability and conductivity of ionic liquids used in the membrane assemblies described herein can vary significantly depending on the characteristics and requirements of the electrochemical reactions involved with sensing the gas in question. In one exemplary embodiment, an ionic liquids used in these electrode assemblies can have electrochemical stability of from 0 V to 6 V (vs. SHE), more specifically, from 0 to 4.5 V (vs. SHE), and/or a conductivity between 1 mS/cm and 100 mS/cm.

Ionic liquids are well-known, and have been the subject of significant study and research. Ionic liquids tend to be air and water stable. Exemplary cations for ionic liquids used in the embodiments described herein include, but are not limited to imidazolium (e.g., 1-ethyl-3-methylimidazolium, 1 ethyl-2,3-dimethylimidazolium, 1-butyl-3-methylimidazolium (“BMI”), 1-hexyl-3-methyl-imidazolium (“HMI”), pyridinium (e.g., N methylpyridinium), tetraalkylammonium, pyrrolidinium (e.g., 1-butyl-1-methyl-pyrrolidinium (“BMPyr”), trialkylsulfonium (e.g., triethylsulfonium), pyrazolium, triazolium, thiazolium, oxazolium, pyridazinium, pyrimidinium, pyrazinium. Exemplary anions for ionic liquids used in the embodiments described herein include, but are not limited to, tetrafluoroborate (BF₄), hexafluorophosphate (PF₆), trifluoromethanesulfonate (CF₃SO₃), trifluoroethanoate, bis(trifluoromethylsulfonyl)imide (NTf2), nitrate, SON, HSO₄, HCO₃, CH₃SO₃, CH₃CH₂SO₄, (CH₃(CH₂)₃O)₂POO, (CF₃SO₂)₂N, dicyanamide, (CF₃CF₂SO₂)₂N, L-(+)-lactate, CH₃SO₄, and CH₃COO, and the like.

In one exemplary embodiment, the ionic liquid has a cation that is an imidazolium, and more specifically the ionic liquid may have the formula:

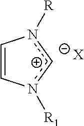

wherein, R and R1 are independently selected from hydrogen, an unsubstituted or substituted alkyl group having 1 to 30 carbon atoms, or an unsubstituted or substituted aryl group having 6 to 30 carbon atoms. X^{⊖} is an anionic group, as described hereinabove, that associates with imidazolium to form an ionic-liquid cation/anion pair.

Besides ionic liquids, organic solvents can also be used to modify the polymer electrolyte for ammonia sensing. Unlike non-volatile ionic liquids, most organic solvents have finite vapor pressure that inevitably would lead to evaporation of the solvents in atmosphere. Thus the solvents with relatively lower vapor pressure are preferred. Candidate solvents include propylene carbonate (PC), ethylene carbonate (EC), dimethyl carbonate (DMC), N-methyl formamide (NMF), dimethyl sulfoxide (DMSO), dimethyl acetamide (DMA), γ-butyrolactone (GBL) or any combination of these solvents. Properties of many of these organic solvent impregnated Nafion have been reported in literature (see, for example, Marc Doyle, et al. J. Phys. Chem. B 2001, 105, 9387-9394, incorporated herein by reference in its entirety).

As described herein, the ionic liquid and organic solvent are used to primarily impregnate the polymer electrolyte in the paired gas diffusion electrodes, secondarily in a polymer membrane disposed between two electrodes. Retention of the ionic liquid or organic solvent in the membrane may be achieved, for example, by including a polymer matrix in the membrane having porosity characteristics such that ionic liquid and organic solvent can be retained within pores, cells, or other interstitial spaces in the polymer matrix. The term matrix includes any configuration of polymer segments and interstitial space between polymer segments that is available for occupation by the molecules and/or atoms of the ionic liquid atoms/molecules, and is not limited to any particular type of regular or irregular configuration. The scale of interspersed polymer segments and ionic liquid can be from angstrom to sub-micrometer, with ionic liquid and organic solvent molecules and/or atoms interspersed with polymer chain molecules and retained in the matrix by physical adsorption, molecular entanglements, or the ionic liquid and organic solvent can be retained in larger polymer segments and structures such as mesoporous polymer structures or microcellular polymer foam structures. Ionic liquids and organic solvents can be integrated with the polymer matrix using various known techniques, including but not limited to forming a solution that includes a polymer and an ionic liquid and casting a film from the solution, diffusing an ionic liquid into a pre-formed polymer membrane structure (e.g., by dipping or soaking), or melt-blending a polymer with an ionic liquid and casting or extruding a film from the blended melt or other polymer membrane forming techniques known in the art. Specifically, ionic liquids can be loaded in an ionomer by ion exchanging. Extra amount of ionic liquids will then be loaded by the physical impregnation processes aforementioned.

Ionic liquid molecules can also be chemically retained in the polymer membrane by grafted with the polymer. In one exemplary embodiment, an imidazolium is attached as a pendant group on a polymer backbone. For example, an imidazolium can be covalently tethered as a pendant group on a polymer's backbone (such as polyethylene, see U.S. Pat. No. 7,897,661, incorporated herein by reference in its entirety) or a polymer's side chain (such as on the phenyl ring of polystyrene, see: Langmuir 2004, 20, 596-605, incorporated herein by reference in its entirety). In another exemplary embodiment, an imidazolium is incorporated into a polymer backbone. For example, an imidazolium can be inserted into a polyethylene backbone or a polyoxyalkylene ester backbone (see, for example, Journal of Membrane Science, 2011, 1-2, 1-4, incorporated herein by reference in its entirety) to form main-chain imidazolium polymers. An anionic group (such as its corresponding H+ form acid, X^{⊖}—H^{⊕}), which can associate with imidazolium, can be directly added into imidazolium-containing polymer, or tethered on the same or different polymers and then mix, either intramolecular (the former cases) or intermolecular (the latter cases), with imidazolium to form an ionic-liquid cation/anion pair, see Nature Materials, 2009, 8, 621, incorporated herein by reference in its entirety.

The electrode assemblies described herein are useful in gas sensors, the configurations of which can vary widely, and are well-known in the art. The MEA can function in environments of low or no humidity, and therefore the provision of a source of water vapor to the polymer membrane is optional, and in some embodiments the sensor is free of any water reservoir. In some embodiments, a water reservoir or other source of water vapor to the membrane may be useful. For example, humidity can impact the sensitivity of sensors utilizing exemplary embodiments of the electrode assemblies described herein, and providing a source of water vapor can provide a desired sensitivity.

In the embodiment of FIG. 1, during NH₃ sensing operation the upper housing 26 is electrically coupled with power, for example V_{CC}, and the lower housing 28 is electrically coupled with ground as depicted. Further, the anode 16 is electrically coupled with power through the electrically conductive first current collector 20 and through the electrically conductive upper housing 26, such that a current path from power to the anode 16 is established through the upper housing 26 and the first current collector 20. Additionally, the cathode 18 is electrically coupled with ground through the electrically conductive second current collector 22 and through the electrically conductive lower housing 28, such that a current path from the cathode 18 to ground is established through the second current collector 22 and the lower housing 28.

During operation in the absence of ammonia, the anode 16 is in a stable state, the ion pump or proton pump from the anode 16 to the cathode 18 across the membrane 14 is not active, and thus there is an electrical open (i.e., unbiased operation or open circuit) between the upper housing 26 and the lower housing 28.

During operation of the device in the presence of ammonia, ammonia enters the opening 27 in the upper housing portion 27 and is absorbed by the ammonia-porous first current collector 20. Ammonia filters through the first collector 20 and makes physical and chemical contact with the anode 16. Chemical reaction of the ammonia with the anode begins the ion pump and generates an abundance of free protons, which are transferred to the cathode 22 through the ionic liquid within the membrane 14 to decrease the electrical resistance between the anode 16 to the cathode 18, thus resulting in an electrical short (i.e., biased operation or closed circuit) and completing the electrical circuit between power and ground. Detection of the presence of a voltage or current between the upper housing 26 and the lower housing 28 thus signals the presence of ammonia.

In an embodiment, the sensor is preferred to operate as an amperometric mode where the current generated or sufficient to excite the sensor is proportional to the ammonia concentration. As an example, the sensor is regulated by a potentiostat integrated circuit for adjusting the bias of the sensing electrode, i.e. anode, and a supervision circuit for imposing inquiry to initiate the measurement, process signal, and perform diagnostics for calibration and detecting fault. To improve selectivity of ammonia detection, unbiased (i.e., open circuit) and biased (i.e., closed circuit) operation, either positively or negatively, can be implemented. In the absence of NH₃, a voltage across the membrane 14 between the anode 16 and the cathode 18 remains at or near 0V. Deviation from this state indicates the presence of chemicals that may interfere with the Nernstian equilibrium. With the impregnated sensing electrodes, identifications of these chemicals are generally revealed. Further, excitation is applied to the sensing electrode to ascertain the identification of the chemical as ammonia, and its concentration is determined according to calibration curves embedded in the signal processing algorithm. Up to 400 mV bias is generally sufficient. In the alternative, the excitation can be applied regularly without solely relying on the open circuit voltage as the indicator of the presence of ammonia. The aperture provides an additional way to ensure that the sensor is responsive to the presence of ammonia within the concentration range expected during use. Specifically, the flux of ammonia concentration can be proportionally adjusted by the aperture size for to the expected ammonia concentration, so that the sensor may remain sensitive under a high concentration exposure environment.

Thus various embodiments of the present teachings provide an ammonia sensor that uses functionalized gas diffusion electrodes to detect ammonia. The electrochemical sensor includes an anode for chemical sensing and a cathode for a counter reaction.

According to an exemplary embodiment, an ammonia sensor may include a housing, a membrane electrode assembly (MEA) within the housing, the MEA including a sensing electrode, a counter electrode, and a polymer membrane disposed between the sensing electrode and the counter electrode. The electrodes, in particular sensing electrode, may include an ionomer-impregnated catalyst gas diffusion layer with an ionic liquid retained therein. The sensor may further include a chamber for reference gas to which the counter electrode is exposed, and a chamber for test gas to which a gas to be tested is exposed. The sensor may also include a pathway for test gas to enter the chamber, a measurement electrical circuit connecting the sensing electrode and the counter electrode, and an electrical circuit.

In another exemplary embodiment, the electrodes in the MEA include an ionomer impregnated catalyst layer where an organic solvent is retained in the ionomer matrix. In another exemplary embodiment, the gas diffusion electrodes may be fabricated by impregnating an electronic conductor, such as carbon, supported precious metal catalysts with an ionomer that an ionic liquid is retained in. In yet another exemplary embodiment, the membrane may include a polymer matrix and an ionic liquid retained in the polymer matrix. In yet another exemplary embodiment, the membrane may include a polymer matrix and an organic solvent retained in the polymer matrix. In still another exemplary embodiment, a membrane and an ionomer in within a pair of electrodes may include a proton-conducting ionic liquid molecule or moiety grafted to a polymer repeat unit or matrix.

While FIG. 1 depicts a laminated sensing device, the sensor may include a planar design formed by ink jet printing or screen printing. A planar design would be compatible with a flexible printed circuit (i.e., flex circuit) design.

In summary, an embodiment of the present teachings may include ionomer-impregnated gas diffusion electrodes that are modified to host selected organic solvents or ionic liquids and reaction agents. The gas diffusion electrodes enable high sensitivity and high selectivity operable over a wide temperature range. Further, during operation, no electrolyte is consumed by the electrochemical reactions and the sensor is thus expected to have an extended lifetime.

In an embodiment, a carbon-supported nano platinum catalyst may be used in the gas diffusion electrodes to achieve high active area using minimal amount of precious metal catalyst. Organic solvents and ionic liquids may be used to enhance the performance of the sensor. Sensitivity to NH₃ may be improved using electrodes that are impregnated with an ionic liquid.

Notwithstanding that the numerical ranges and parameters setting forth the broad scope of the present teachings are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less than 10” can assume negative values, e.g. −1, −2, −3, −10, −20, −30, etc.

While the present teachings have been illustrated with respect to one or more implementations, alterations and/or modifications can be made to the illustrated examples without departing from the spirit and scope of the appended claims. For example, it will be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It will be appreciated that structural components and/or processing stages can be added or existing structural components and/or processing stages can be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items can be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. Finally, “exemplary” indicates the description is used as an example, rather than implying that it is an ideal. Other embodiments of the present teachings will be apparent to those skilled in the art from consideration of the specification and practice of the disclosure herein. It is intended that the specification and examples be considered as exemplary only, with a true scope and spirit of the present teachings being indicated by the following claims.

Terms of relative position as used in this application are defined based on a plane parallel to the conventional plane or working surface of a workpiece, regardless of the orientation of the workpiece. The term “horizontal” or “lateral” as used in this application is defined as a plane parallel to the conventional plane or working surface of a workpiece, regardless of the orientation of the workpiece. The term “vertical” refers to a direction perpendicular to the horizontal. Terms such as “on,” “side” (as in “sidewall”), “higher,” “lower,” “over,” “top,” and “under” are defined with respect to the conventional plane or working surface being on the top surface of the workpiece, regardless of the orientation of the workpiece.

1. An ammonia sensor, comprising:
a gas diffusion sensing electrode comprising a first catalyst support, a first nanocatalyst, and a first ion-conducting ionomer film with porosity ranging from 20% to 80%, wherein the first nanocatalyst and the first ion-conducting ionomer film are supported by the first catalyst support and the ionomer is impregnated with ionic liquids;
a membrane comprising an ion conducting polymer;
a gas diffusion counter electrode comprising a second catalyst support, a second nanocatalyst, and a second ion-conducting ionomer film, wherein the second nanocatalyst and the second ion-conducting ionomer film are supported by the second catalyst support, wherein the membrane is directly interposed between the sensing electrode and the counter electrode;
a first housing portion electrically coupled to the sensing electrode, wherein the first housing portion comprises an opening therein that exposes the sensing electrode to an environment;
a second housing portion electrically coupled to the counter electrode,
wherein the ammonia sensor is configured such that the sensing electrode can be electrically coupled to the counter electrode and the ammonia sensor is configured to determine a presence of ammonia in the environment.

2. The ammonia sensor of claim 1, wherein the polymer matrix of the membrane comprises a sulfonated tetrafluoroethylene based fluoropolymer-copolymer.

3. The ammonia sensor of claim 1, wherein the polymer matrix of the membrane comprises a material selected from the group consisting of polyesters, polyolefins, polyurethanes, acrylic polymers, polyimide, polysulfone, polyarylsulfone, polybenzimidazole, co-polymers, polyetherimide-siloxane copolymers, perfluorinated polymers, and partially fluorinated polymers, polyoxyalkylene, a perfluorinated polymer, a partially fluorinated polymer, polystyrene, and a heteroaromatic polymers.

4. The ammonia sensor of claim 1, wherein the ionic liquid within the ionomer in the electrodes comprises at least one material selected from the group consisting of imidazolium and pyridinium cations, including 1-hexyl-3-methyl-imidazolium, pyridinium, tetraalkylammonium, pyrrolidinium, trialkylsulfonium, pyrazolium, triazolium, thiazolium, oxazolium, pyridazinium, pyrimidinium, pyrazinium, paired with one or more of the following anionic species: tetrafluoroborate, hexafluorophosphate, trifluoromethanesulfonate, trifluoroethanoate, bis(trifluoromethylsulfonyl)imide, nitrate, SCN, HSO₄, HCO₃, CH₃SO₃, CH₃CH₂SO₄, (CH₃(CH₂)₃O)₂POO, (CF₃SO₂)₂N, dicyanamide, (CF₃CF₂SO₂)₂N, L-(+)-lactate, CH₃SO₄, and CH₃COO.

5. The ammonia sensor of claim 1, wherein the ionic liquid within the interstitial spaces comprises the formula: 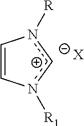
wherein, R and R1 are independently selected from the group consisting of hydrogen, an unsubstituted or substituted alkyl group comprising 1 to 30 carbon atoms, an unsubstituted or substituted aryl group comprising 6 to 30 carbon atoms, X^{⊖} is an anionic group that associates with imidazolium to form an ionic-liquid cation/anion pair.

6. The ammonia sensor of claim 1, wherein the first catalyst support and the second catalyst support are one of an electrically conductive support and an oxide semiconductor.

7. The ammonia sensor of claim 6, wherein the first nanocatalyst and the second nanocatalyst each comprise at least one precious metal selected from the group consisting of platinum, gold, silver, and palladium.

8. The ammonia sensor of claim 1, wherein the first ion-conducting ionomer film and the second ion-conducting ionomer film each comprise a sulfonated tetrafluoroethylene based fluoropolymer-copolymer.

9. The ammonia sensor of claim 1, wherein the first housing portion is configured to be electrically coupled to a potentiostatic or galvanostatic circuitry and signal processing electronics.

10. The ammonia sensor of claim 1, further comprising:
a first current collector electrically coupled to, and interposed between, the first housing portion and the sensing electrode; and
a second current collector electrically coupled to, and interposed between, the second housing portion and the counter electrode.

11. The ammonia sensor of claim 6, wherein the first current collector and the second current collector each comprise at least one of a porous carbon paper and a porous metal felt.

12. A method for detecting the presence of environmental ammonia, comprising:
providing a membrane comprising a polymer matrix, interstitial spaces within the polymer matrix, and an ionic liquid within the interstitial spaces;
providing a gas diffusion sensing electrode comprising a first catalyst support, a first nanocatalyst, and a first ion-conducting ionomer film, wherein the first nanocatalyst and the first ion-conducting ionomer film are supported by the first catalyst support;
providing a gas diffusion counter electrode comprising a second catalyst support, a second nanocatalyst, and a second ion-conducting ionomer film, wherein the second nanocatalyst and the second ion-conducting ionomer film are supported by the second catalyst support, wherein the membrane is directly interposed between the sensing electrode and the counter electrode;
providing a first housing portion electrically coupled to the sensing electrode, wherein the first housing portion comprises an opening therein that exposes the sensing electrode to an environment;
providing a second housing portion electrically coupled to the counter electrode;
detecting the presence or absence of ionic conduction via the membrane between the first housing portion and the second housing portion, wherein charge transfer between the first housing portion and the second housing portion indicates the presence of environmental ammonia and the absence of ionic current between the first housing portion and the second housing portion indicates the absence of environmental ammonia.

13. The method of claim 12, wherein providing the membrane provides a polymer matrix comprising a sulfonated tetrafluoroethylene based fluoropolymer-copolymer.

14. The method of claim 12, wherein providing the membrane provides a polymer matrix comprising a material selected from the group consisting of polyesters, polyolefins, polyurethanes, acrylic polymers, polyimide, polysulfone, polyarylsulfone, polybenzimidazole, co-polymers, polyetherimide-siloxane copolymers, perfluorinated polymers, and partially fluorinated polymers, polyoxyalkylene, a perfluorinated polymer, a partially fluorinated polymer, polystyrene, and a heteroaromatic polymers.

15. The method of claim 12, wherein providing the membrane provides an ionic liquid comprising at least one material selected from the group consisting of imidazolium and pyridinium cations, including 1-hexyl-3-methyl-imidazolium, pyridinium, tetraalkylammonium, pyrrolidinium, trialkylsulfonium, pyrazolium, triazolium, thiazolium, oxazolium, pyridazinium, pyrimidinium, pyrazinium; paired with one or more of the following anionic species tetrafluoroborate, hexafluorophosphate, trifluoromethanesulfonate, trifluoroethanoate, bis(trifluoromethylsulfonyl)imide, nitrate, SCN, HSO₄, HCO₃, CH₃SO₃, CH₃CH₂SO₄, (CH₃(CH₂)₃O)₂POO, (CF₃SO₂)₂N, dicyanamide, (CF₃CF₂SO₂)₂N, L-(+)-lactate, CH₃SO₄, and CH₃COO.

16. The method of claim 12, wherein providing the membrane provides an ionic liquid comprising the formula: 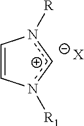
wherein, R and R1 are independently selected from the group consisting of hydrogen, an unsubstituted or substituted alkyl group comprising 1 to 30 carbon atoms, an unsubstituted or substituted aryl group comprising 6 to 30 carbon atoms, X^{⊖} is an anionic group that associates with imidazolium to form an ionic-liquid cation/anion pair.

17. The method of claim 12, wherein:
providing the sensing electrode provides a first catalyst support comprising at least one of an electrically conductive support and an oxide semiconductor; and
providing the counter electrode provides a second catalyst support comprising at least one of an electrically conductive support and an oxide semiconductor.

18. The method of claim 17, wherein:
providing the sensing electrode provides a first nanocatalyst comprising at least one precious metal selected from the group consisting of platinum, gold, silver, and palladium; and
providing the counter electrode provides a second nanocatalyst comprising at least one precious metal selected from the group consisting of platinum, gold, silver, and palladium.

19. The method of claim 18, wherein:
providing the sensing electrode provides a first ion-conducting ionomer film comprising a sulfonated tetrafluoroethylene based fluoropolymer-copolymer; and
providing the counter electrode provides a second ion-conducting ionomer film comprising a sulfonated tetrafluoroethylene based fluoropolymer-copolymer.

20. The method of claim 12, further comprising:
providing a first current collector comprising at least one of a porous carbon paper and a porous metal felt electrically coupled to, and interposed between, the first housing portion and the sensing electrode; and
providing a second current collector comprising at least one of a porous carbon paper and a porous metal felt electrically coupled to, and interposed between, the second housing portion and the counter electrode.
